(19) United States
(12) Patent Application Publication
(10) Pub. No.: US 2006/0082272 A1
(43) Pub. Date: Apr. 20, 2006

(54) Plasma display apparatus

(76) Inventors: Ki-Jung Kim, Suwon-si (KR); Hyouk Kim, Suwon-si (KR); In-Soo Cho, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/222,156

(22) Filed: Sep. 7, 2005

(30) Foreign Application Priority Data
Sep. 24, 2004 (KR) 10-2004-0077064
Apr. 27, 2005 (KR) 10-2005-0034944

(51) Int. Cl. H01J 7/24

(52) U.S. Cl. 313/46; 313/582

(57) ABSTRACT

A plasma display apparatus embodiment comprising a plasma display panel, a chassis base supporting the plasma display panel, double-sided tape attached on the chassis base to hold and fix the PDP, and alignment marks, formed on the chassis base, to guide the attachment of the double-sided tape is disclosed. Also, presented is a plasma display apparatus comprising a plasma display panel, a chassis base supporting the plasma display panel, heat spread sheets placed between the plasma display panel and the chassis base, and alignment marks, formed on the chassis base, to guide the positioning of the heat spread sheets.

### CROSS-REFERENCES TO RELATED APPLICATION

This application claims the benefit of and priority to Korean Patent Application No. 10-2004-0077064 filed on Sep. 24, 2004; No. 10-2005-0034944 filed on Apr. 27, 2005 in the Korean Intellectual Property Office, the entire disclosures of which are incorporated herein by reference.

### BACKGROUND OF THE INVENTION

1. Field of the Invention

The present invention relates to a plasma display apparatus and, in particular, to the effective arrangement and attachment of heat spread sheets and double-sided tapes between a plasma display panel and a chassis base thereof.

2. Description of the Related Technology

It is well known that a plasma display apparatus uses plasma generated by gas discharge to produce an image on a plasma display panel (PDP). The plasma display apparatus comprises a PDP; a chassis base of which a first side supports the PDP; driving circuit boards, attached on a second side, the second side opposite the first side of the chassis base where the PDP is supported, the driving circuit boards being electrically connected to support and address electrodes of the PDP via a flexible printed circuit and connectors; and a case housing the PDP, the chassis base, and the driving circuit boards, and forming an external case of the plasma display apparatus.

FIG. 17 is a perspective view of a prior plasma display apparatus showing assembling a unit module. FIG. 18 is a plan view of a chassis base of a prior plasma display apparatus.

According to FIGS. 17 and 18, a PDP 110 placed inside the case is attached to a chassis base 120 via double-sided tapes 140. The chassis base 120 is made of a metallic material with a high mechanical strength to support the PDP 110. A heat spread sheet 130 is placed between the PDP 110 and the chassis base 120 for transferring heat from the PDP 110 to the chassis base 120.

The PDP 110 is made of two hermetically sealed glass substrates facing each other and having discharge cells therebetween. The PDP 110 is shock-sensitive and fragile in terms of mechanical strength. The PDP 110 produces a large amount of heat during its operation and has a heat spread sheet 130 on the backside thereof. The heat spread sheet 130 spreads the heat from the PDP 110 in the plane-wise direction effectively.

In addition to the role of maintaining the mechanical strength of the PDP 110, the chassis base 120 serves as a mount for supporting the driving circuit boards, as a heat sink for dissipating heat from the PDP 110 and as a ground for the electro magnetic interference (EMI) of the PDP 110.

For the purpose of the heat dissipation of the PDP 110, it is desirable for the heat spread sheet 130 to be as wide as possible on the backside thereof and for the double-sided tape to be placed to fix the PDP 110 to the chassis base 120 firmly without engaging the heat spread sheet 130.

In order to ease installation of the double-sided tape 140, a clearance C between the heat spread sheet 130 and the double-sided tape 140 may be increased. A large clearance, however, causes a bright image-sticking on the portion of the viewing surface of the PDP 110 corresponding to the clearance C. Bright image-sticking is the phenomenon that faint images remain despite having been over-written.

A small clearance C may eliminate the bright image-sticking, but may increase the likelihood of the double-sided tape 140 engaging the heat spread sheet 130 of the PDP 110 when the PDP 110 is attached to the chassis base 120.

Therefore, the double-sided tapes 140 should be placed at exact locations in order to minimize the clearance C between the heat spread sheet 130 and the double-sided tape 140.

A typical process for assembling the PDP 110, the chassis base 120 and the heat spread sheet 130 includes attaching the heat spread sheet 130 on the backside(opposite the viewing surface) of the PDP 110, attaching the double-sided tapes 140 on the chassis base 120, and fixing the PDP 110 to the chassis base 120 by means of the double-sided tapes 140.

When the double-sided tapes 140 are incorrectly positioned, the clearance C between the heat spread sheet 130 and the double-sided tapes 140 is not uniform and may be locally larger than a predetermined minimum and therefore cause the aforementioned bright image sticking.

Moreover, the severely severe misalignment can cause the double-sided tapes 140 to engate the heat spread sheet 130. This can leave gaps between the heat spread sheet 130 and the chassis base 120, which is responsible for noise in the assembled unit.

### SUMMARY OF CERTAIN INVENTIVE ASPECTS

In accordance with inventive aspects, a plasma display apparatus includes double-sided tapes and heat spread sheets which are effectively arranged and attached at positions between the plasma display panel and the chassis base.

Also, the plasma display apparatus aspects are provided in which the attachment process of double-sided tapes is easily carried out, and clearances between the heat spread sheets and the double-sided tapes are minimized by monitoring the double-sided tapes and the attachment positions corresponding to the heat spread sheets during the assembling process.

Another objective of inventive aspects is to provide the plasma display apparatus that prevents effectively the bright image-sticking happening due to non-uniform clearance between the double-sided tape and the heat spread sheet by means of attaching the double-sided tape and the heat spread sheet at positions with a uniform clearance and therefore, reduces noise coming out of the unit module due to the wrong attachment of the double-sided tape and the heat spread sheet.

In accordance with inventive aspects, a plasma display apparatus comprises a plasma display panel; a chassis base supporting the plasma display panel; double-sided tapes attached on the chassis base to hold and fix the PDP; and alignment marks, formed on the chassis base, to guide the attachment positions of the double-sided tapes.

In a further embodiment, a plasma display apparatus comprises a plasma display panel; a chassis base supporting the plasma display panel; heat spread sheets placed between the plasma display panel and the chassis base; and alignment marks, formed on the chassis base, to guide the positions of the heat spread sheets. The heat spread sheet is divided by a plurality of pieces, the piece spaced apart from one another by a predetermined gap. And the double-sided tapes, attached on the chassis base, positioned between the heat spread sheets and outside the heat spread sheets to form a band by pieces of the double-sided tapes.

The alignment marks may be formed on a side of the chassis base, the side facing the plasma display panel, and formed at positions between the heat spread sheets neighboring each other.

The alignment marks may be formed at positions corresponding to some of the double-sided tapes at least.

The alignment marks may be formed by embossing or recessing the attachment surface of the double-sided tapes on the chassis base and may be formed by printing in ink or in a fluorescent material.

The alignment marks may be formed all along the perimeter of the attachment surface of the double-sided tapes or formed partially along the perimeter of the attachment surface.

The alignment marks may be partially formed in a pair at positions along two lengthwise edges or two widthwise edges of the double-sided tape or at two diagonal positions of the double-sided tape.

The alignment marks may be partially formed in a pair at two diagonal corners of the double-sided tape. The alignment mark is formed into a partial bracket type matching to the corner shape of the double-sided tape or a hole punched partially on the chassis base. The hole may have a circular or a polygonal cross-section.

### BRIEF DESCRIPTION OF THE DRAWINGS

FIG. 1 is a perspective view of a disassembled plasma display apparatus according to a first embodiment.

FIG. 2 is a plan view of a chassis base of the plasma display apparatus according to the first embodiment.

FIG. 3 is a side cross-section taken on the section line III-III of FIG. 2.

FIG. 4 is a side cross-section of a chassis base of a plasma display apparatus according to a second embodiment.

FIG. 5 is a plan view of a chassis base of a plasma display apparatus according to a third embodiment.

FIG. 6 is a plan view of a chassis base of a plasma display apparatus according to a fourth embodiment.

FIG. 7 is a side cross-section taken on the section line VII-VII of FIG. 6.

FIG. 8 is a perspective view of a disassembled plasma display apparatus according to a fifth embodiment.

FIG. 9 is a plan view of a chassis base shown in FIG. 8.

FIG. 10 is a plan view of a chassis base of a plasma display apparatus according to a sixth embodiment.

FIG. 11 is a plan view of a chassis base of a plasma display apparatus according to a seventh embodiment.

FIG. 12 is a plan view of a chassis base of a plasma display apparatus according to an eighth embodiment.

FIG. 13 is a plan view of a chassis base of a plasma display apparatus according to a ninth embodiment.

FIG. 14 is a plan view of a chassis base of a plasma display apparatus according to a tenth embodiment.

FIG. 15 is a plan view of a chassis base of a plasma display apparatus according to an eleventh embodiment.

FIG. 16 is a plan view of a chassis base of a plasma display apparatus according to a twelfth embodiment.

FIG. 17 is a perspective view of a prior plasma display apparatus showing assembling a unit module.

FIG. 18 is a plan view of a chassis base of a prior plasma display apparatus.

### DETAILED DESCRIPTION OF CERTAIN INVENTIVE EMBODIMENTS

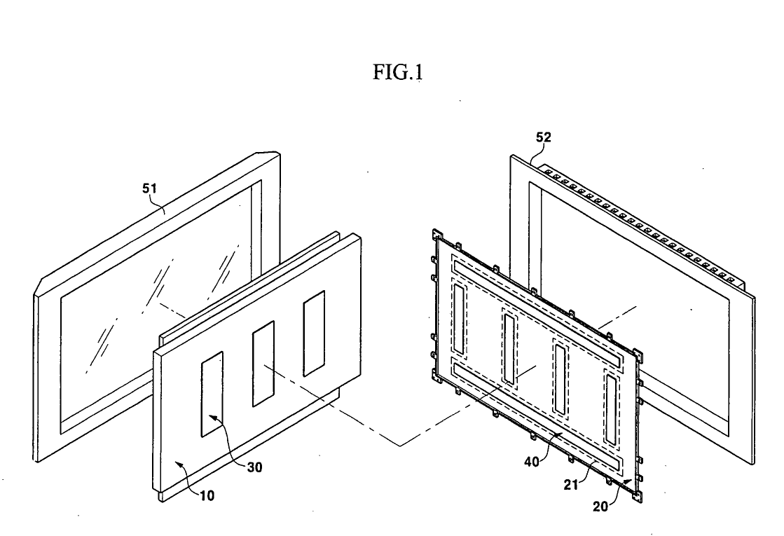

As shown in FIG. 1, a plasma display apparatus comprises a plasma display panel (PDP) 10 which produces an image by plasma discharge; a chassis base 20 positioned on a backside of the PDP 10, the backside being opposite to the viewing surface, and supporting the PDP 10; heat spread sheets 30 placed between the PDP 10 and the chassis base 20; double-sided tapes 40, maintaining a predetermined clearance from the heat spread sheet 30, and being attached on the chassis base 20 to fix the PDP 10 to the chassis base 20; a front cover 51 placed over the front of the PDP 10; and a rear cover placed over the back of the chassis base 20.

The PDP 10 is a display device using gas discharge, and the present invention relates to a configuration of the PDP 10 and other components and a method of manufacturing the same. Therefore, the detailed explanation of the PDP 10 itself is omitted, and the PDP 10 of the present invention may have various compositions and forms.

The heat spread sheet 30 serves to uniformly dissipate the heat generated from the PDP 10 to eliminate the bright image sticking of the PDP 10. The heat spread sheet 30 may be made of a material such as acrylic, graphite or carbon-nano tube material, or other such material known in the art.

A single large piece of the heat spread sheet 30 may be attached on the backside of the PDP 10 for uniform heat dissipation. Alternatively, a plurality of pieces may be similarly attached. For example, 3 pieces may be used.

When the PDP 10 has a plurality of pieces of the heat spread sheets 30 attached thereto, double-sided tapes 40 may be placed between each piece of the heat spread sheets 30.

The heat spread sheet 30 is placed between the PDP 10 and the chassis base 20 joined to the PDP 10 and pressed to be in a firm contact with the backside of the PDP 10 by the bonding force of the double-sided tape 40. Therefore, it is preferable for the double-sided tape 40 to have a sufficient bonding force to maintain the firm attachment of the chassis base 20 to the PDP 10. The double-sided tapes 40 are placed between the plurality of heat spread sheets 30 and bond at multiple locations to the backside of the PDP 10 and the chassis base 20.

The double-sided tapes 40 in this case increase the bonding strength between the PDP 10 and the chassis base 20. However, they also may cause non-uniform heat dissipation in the backside of the PDP 10 due to the decrease in area covered with the heat spread sheet 30. Therefore, it is preferable to use a proper number of the heat spread sheet 30 so as not to cause the non-uniform heat dissipation.

Accordingly, the heat spread sheet 30 is divided into plural pieces, and each piece is positioned on the backside of the PDP 10 at predetermined locations. The double-sided tapes 40 may be placed between and outside the pieces of the heat spread sheet 30 to form a band of pieces of the double-sided tape 40 around the heat spread sheets 30 to attach the chassis base 20 to the backside of the PDP 10.

Driving circuit boards (not shown) for driving the PDP 10 are attached on a backside of the chassis base 20, the backside being opposite to the side where the PDP 10 is attached.

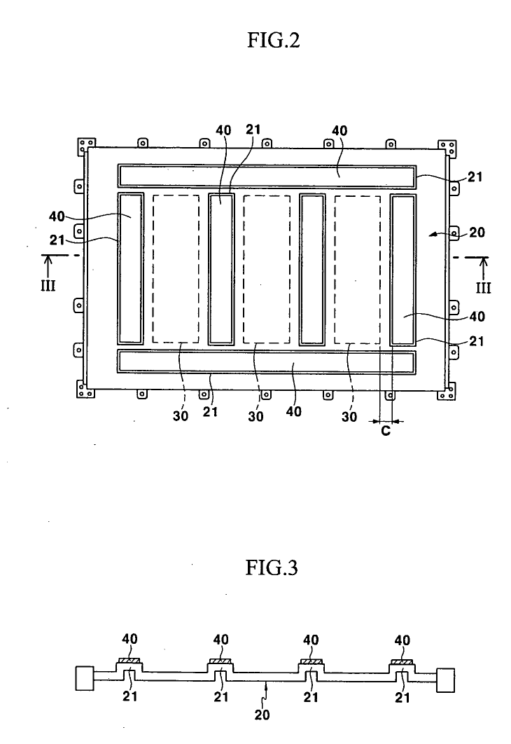

On the chassis base 20, as shown in FIG. 2 and FIG. 3, are formed alignment marks 21 to guide the placement of the double-sided tapes 40. The alignment marks 21 ensure that the tapes are attached at correct positions on the chassis base 20. The marks are positioned such that the double-sided tapes 40 maintain a predetermined clearance C from the heat spread sheet 30. During the assembling process, the embossed alignment marks 21 guide a worker (or a working machine in an automated line) to place the double-sided tapes 40 and the heat spread sheet 30 at more accurate positions.

The alignment mark 21 may be formed by embossing the entire surface where the double-sided tape is to be attached.

Correctly positioned double-sided tapes 40 provide consistent and uniform clearance C from the heat spread sheet 30. With better control, the Clearance C may be reduced enough to effectively eliminate the bright image-sticking.

Since the alignment marks 21 guide the correct placement of the double-sided tapes 40. The heat spread sheet 30 will not engage the tapes. Local gaps between the PDP 110 and the chassis base 120, will be avoided and noise from such gaps eliminated.

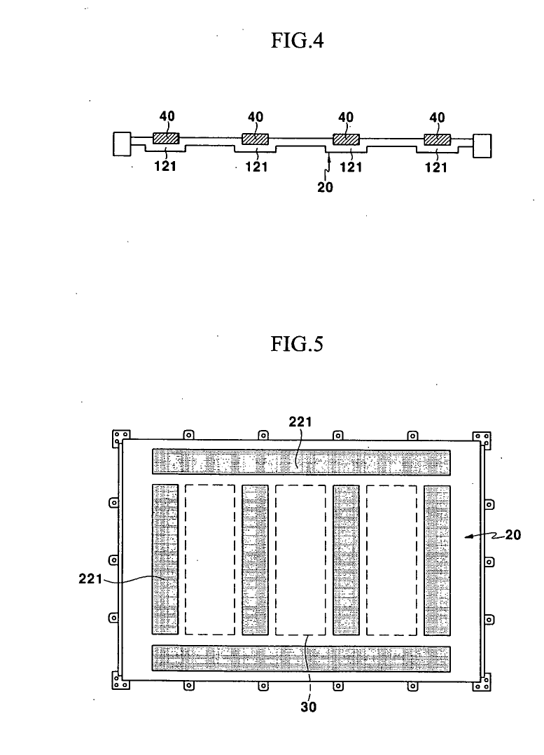

FIG. 4 is a side cross-section of a chassis base of a plasma display apparatus according to a second embodiment of the present invention. According to FIG. 4, the alignment mark 121 of the present embodiment is formed by recessing the entire attachment surface where the double-sided tape 40 is attached.

The recessed alignment mark 121 is preferable for manufacturing the chassis base 20 by a press. Alternatively, both recessed and embossed alignment marks 121 are possible. The chassis base 20 may be manufactured by use of a die-casting.

FIG. 5 is a plan view of a chassis base of a plasma display apparatus according to a third embodiment of the present invention. The alignment mark 221 of the present embodiment, as shown in FIG. 5, is highlighted by printing a mark such as an ink mark or a fluorescent mark on the attachment surface for the double-sided tape 40. This guides a worker (or a working machine) to recognize the attachment surface easily and attach the double-sided tape 40 correctly.

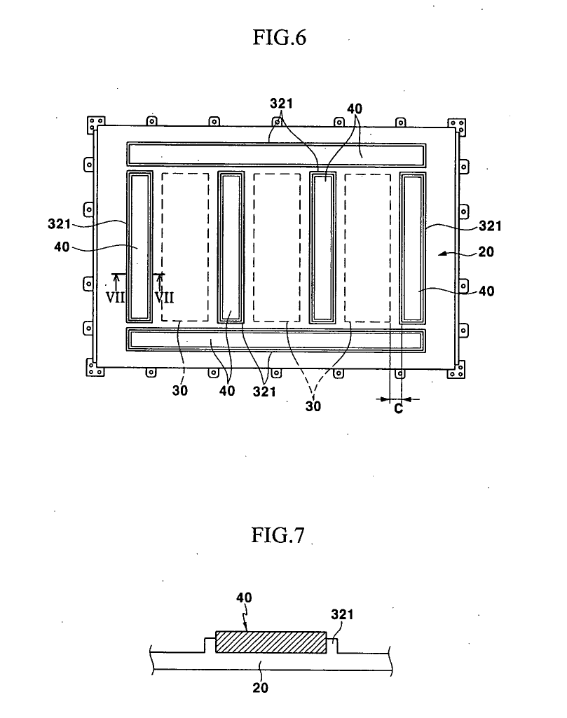

FIG. 6 is a plan view of a chassis base of a plasma display apparatus according to a fourth embodiment of the present invention. And FIG. 7 is a side cross-section taken on the section line VII-VII of FIG. 6. As shown in these figures, the alignment mark 321 by embossing or recessing lines only along the perimeter of the attachment surface of the double-sided tape 40.

The alignment mark 321, as shown in FIG. 7, may be formed by embossing a partial area of the attachment surface for the double-sided tape 40 on the chassis base 20, i.e., a line along the perimeter of the attachment surface for the double-sided tape 40. Therefore, the double-sided tape 40 is guided to be set inside the alignment mark 321. The alignment mark 321 may be printed in ink or fluorescent material or other materials along the perimeter of the attachment surface for the double-sided tape 40.

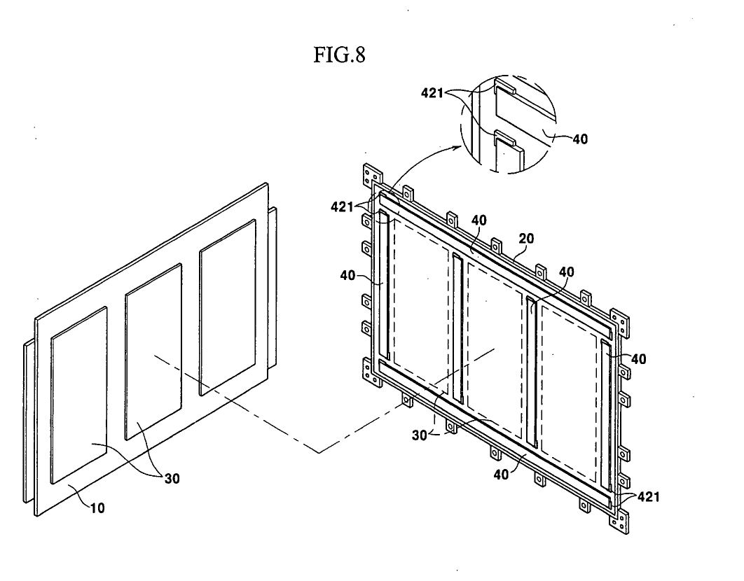

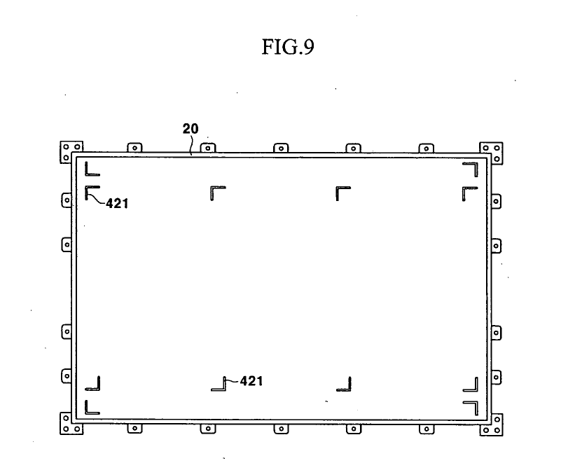

FIG. 8 is a perspective view of a disassembled plasma display apparatus according to a fifth embodiment of the present invention. And FIG. 9 is a plan view of a chassis base shown in FIG. 8. As shown in these figures, the alignment mark 421 is formed at least partly along the perimeter of the attachment surface for the double-sided tape 40. In order to minimize the alignment mark area needed for guiding the double-sided tape 40, the alignment marks 421 are located at two diagonal corners of the rectangular attachment surface for the double-sided tape 40, and are formed in a partial bracket shape “ [symbol] ”, “ [symbol] ”. Other shapes such as, but not limited to, broken lines, or dots or pairs or multiple instances of these shapes.

For example, the alignment marks may be formed in a pair along two lengthwise edges or two widthwise edges of the double-sided tape 40.

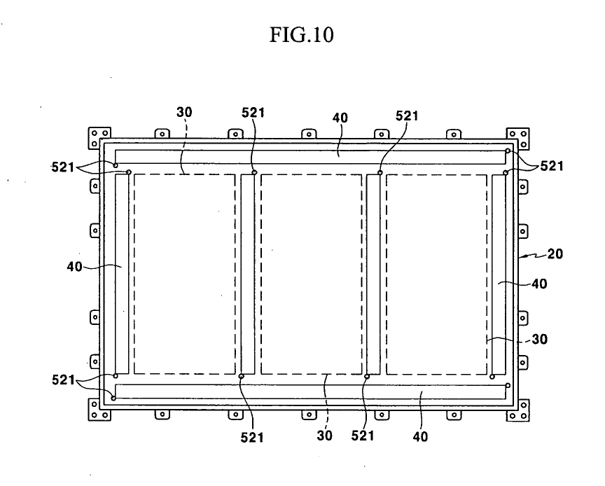

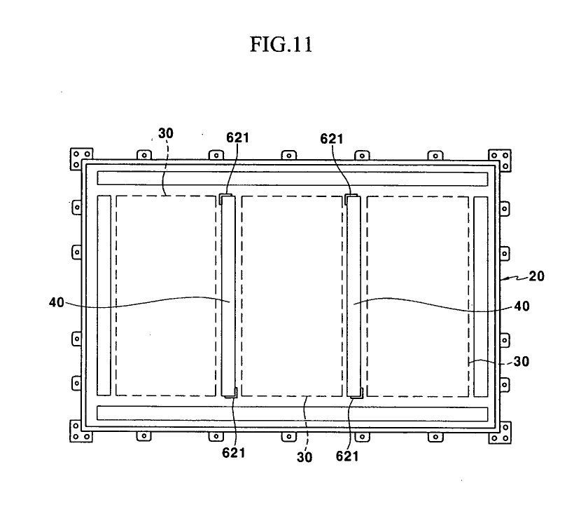

FIG. 10 is a plan view of a chassis base of a plasma display apparatus according to a sixth embodiment of the present invention. According to FIG. 10, the alignment mark 521 of the present embodiment is a circular hole. Such a hole may be made by punching the chassis base 20. The chassis base 20 may be made of a metallic material so that punching is convenient. In order to minimize the punching process the alignment marks 521 may be located at two diagonal corners of the rectangular attachment surface for the double-sided tape 40.

FIG. 11 is a plan view of a chassis base of a plasma display apparatus according to a seventh embodiment of the present invention. According to FIG. 11, the alignment marks 621 of the present embodiment may be formed at positions corresponding to all or to a portion of the double-sided tapes 40 on the chassis. For example, the alignment marks 621 may be formed between the heat spread sheets 30 and not outside the heat spread sheets 30. Alternatively the marks may be formed outside the heat spread sheets 30 and not inside the heat spread sheets 30. Using this arrangement, the number of the alignment marks 621 may be minimized.

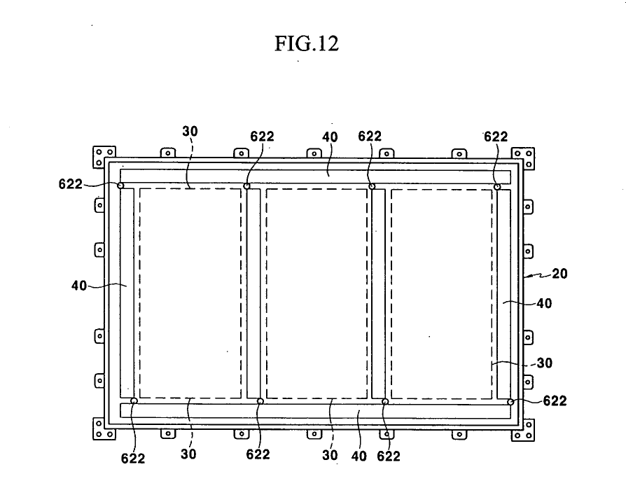

FIG. 12 is a plan view of a chassis base of a plasma display apparatus according to a eighth embodiment of the present invention. According to FIG. 12, the alignment marks 622 of the present embodiment are formed for some, but not all of the double-sided tapes 40 on the chassis base 20. In this example, the alignment marks 622 are positioned to guide only vertical double-sided tapes 40. In this example, the punched circular alignment marks 622 are located at two diagonal corners of the rectangular attachment surface for the double-sided tape 40 to minimize the alignment mark area. Other embodiments may use other locations such as on an edge.

In other embodiments, the alignment marks 622 may be shared with one or more other double-sided tapes 40. For example, a single alignment mark 622 is used to guide both the horizontal and vertical double-sided tapes 40.

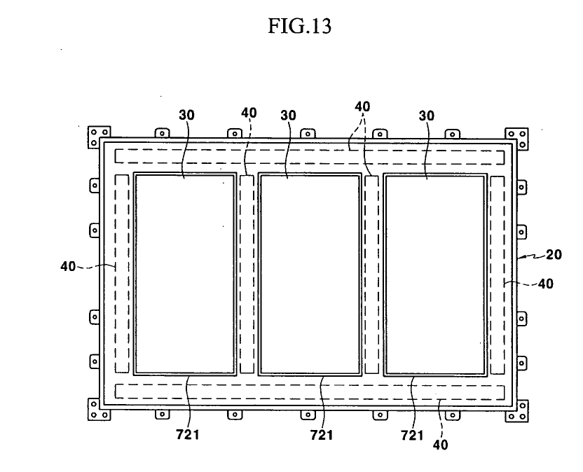

FIG. 13 is a plan view of a chassis base of a plasma display apparatus according to a ninth embodiment of the present invention. According to FIG. 13, the alignment marks 721 of the present embodiment are formed on the chassis base 20 to guide not only the double-sided tapes 40 to be correctly positioned but also to guide the correct positioning of the heat spread sheets 30. Some marks 721 may be for the heat spread sheets 30 and/or some may be for both the double sided tapes 40 and the heat spread sheets 30.

The alignment marks 721 may be formed by embossing or recessing the entire attachment surface on the chassis base 20 corresponding to the heat spread sheet 30, or by printing with ink or a fluorescent material. Other suitable methods may also be used.

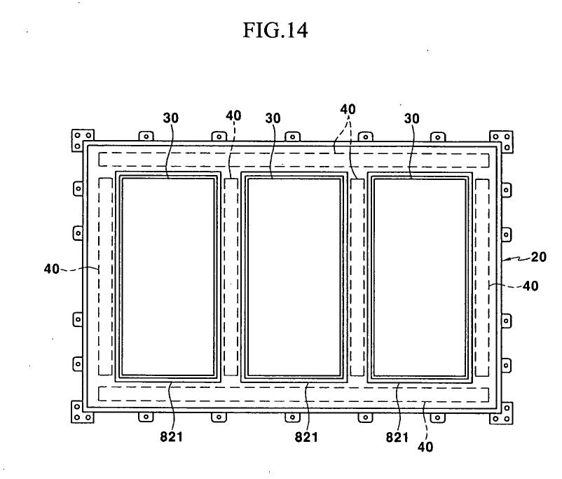

FIG. 14 is a plan view of a chassis base of a plasma display apparatus according to a tenth embodiment of the present invention. As shown in FIG. 14, the alignment mark 821 may be formed along the perimeter of the attachment surface on the chassis base 20 for the heat spread sheet 30.

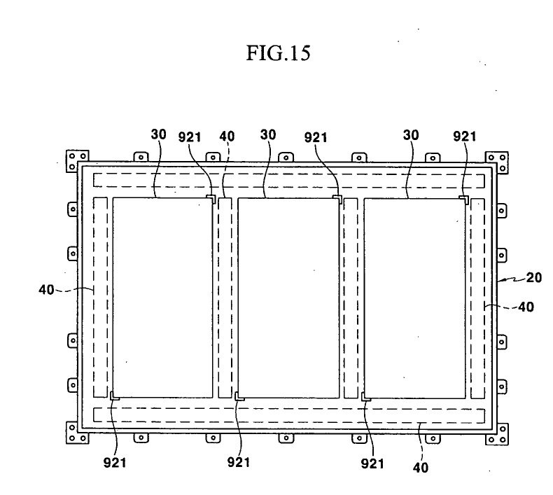

FIG. 15 is a plan view of a chassis base of a plasma display apparatus according to an eleventh embodiment of the present invention. According to FIG. 15, the alignment marks 921 of the present embodiment may be formed along a portion of the perimeter of the areas in the attachment surface for the heat spread sheet 30. The alignment marks 921 may be located at two diagonal corners of the rectangular attachment surface on the chassis base 20 for the heat spread sheet 30. This may be done to minimize the number of alignment marks needed for guiding the heat spread sheet 30.

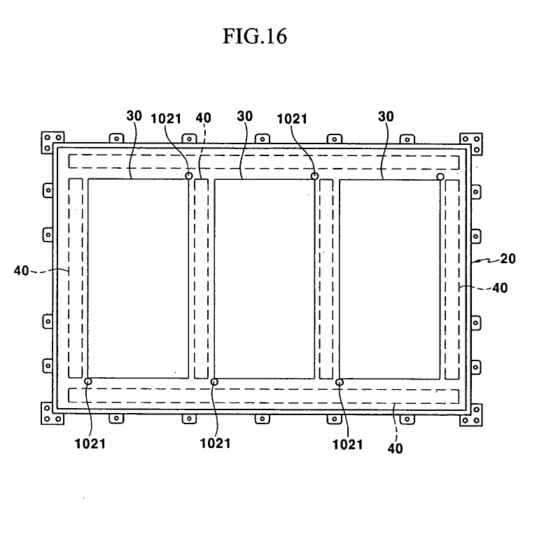

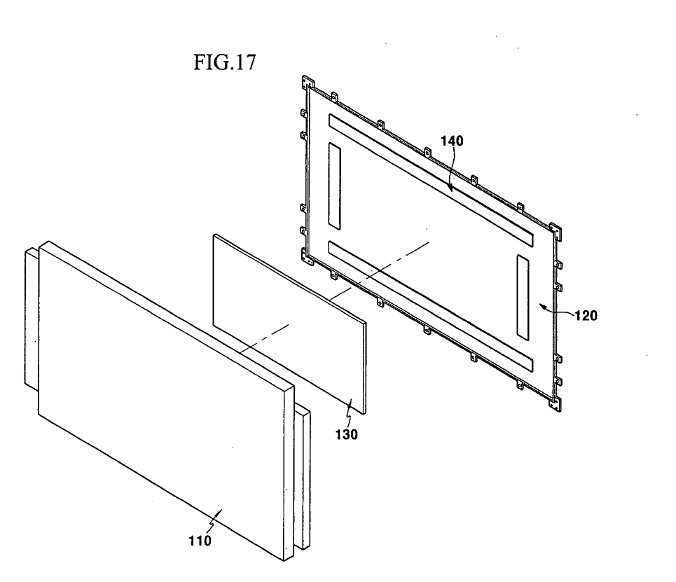

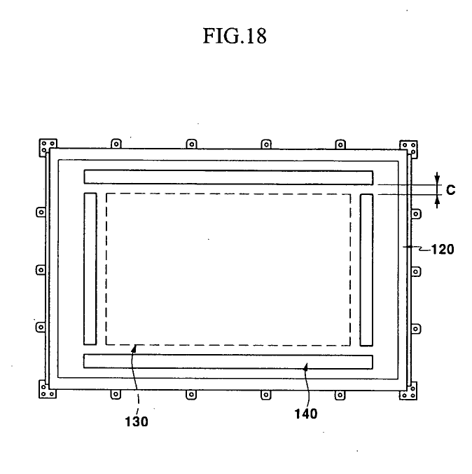

FIG. 16 is a plan view of a chassis base of a plasma display apparatus according to a twelfth embodiment of the present invention.

According to FIG. 16, the alignment mark 1021 of the present embodiment is a set of punched holes at positions near the edges of the attachment surface on the chassis base 20 corresponding to the heat spread sheet 30. In some embodiments the alignment marks 1021 are located at two diagonal corners of the rectangular attachment surface on the chassis base 20

The alignment marks used in all of the embodiments explained above may be used for guiding the double-sided tape 40 or for guiding the heat spread sheet 30 to the correct attachment position.

Although exemplary embodiments of the present invention have been described in detail hereinabove, it should be understood that many variations and/or modifications of the basic inventive concept taught therein will fall within the spirit and scope of the present invention, as defined in the claims.

The plasma display apparatus of the present invention provides an effective way for arranging and attaching the double-sided tapes and the heat spread sheets placed between the plasma display panel and the chassis base.

Also, by monitoring the double-sided tapes and the attachment positions corresponding to the heat spread sheets during the assembling process, the attachment process of double-sided tapes is easily carried out, and clearances between the heat spread sheets and the double-sided tapes are minimized.

Since the alignment marks facilitate the correct attachment of the double-sided tape and the heat spread sheet with a uniform clearance, the present invention substantially prevents effectively the bright image-sticking due to non-uniform clearance between the double-sided tape and the heat spread sheet and noise from the unit module due to the misaligned attachment of the double-sided tape and the heat spread sheet.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display apparatus comprising:
a plasma display panel;
a chassis base supporting the plasma display panel;
double-sided tape to fix the PDP to the chassis base; and
alignment marks, formed on the chassis base, to indicate the attachment positions of the double-sided tape.

2. The plasma display apparatus of claim 1, wherein a heat spread sheet is placed between the chassis base and the plasma display panel, the heat spread sheet being divided into a plurality of pieces being spaced apart from one another by a predetermined gap, and wherein the double-sided tapes are positioned between and outside the heat spread sheets.

3. The plasma display apparatus of claim 1, wherein the alignment marks are formed on a side of the chassis base proximal to the plasma display panel.

4. The plasma display apparatus of claim 3, wherein the alignment marks are formed at positions between adjacent heat spread sheets.

5. The plasma display apparatus of claim 1, wherein the alignment marks are formed at positions corresponding to at least a portion of the double-sided tape.

6. The plasma display apparatus of claim 1, wherein the alignment marks are formed by embossing.

7. The plasma display apparatus of claim 1, wherein the alignment marks are formed by recessing the surface of the chassis base corresponding to the intended position of the double sided tape.

8. The plasma display apparatus of claim 1, wherein the alignment marks are formed by printing ink or fluorescent material.

9. The plasma display apparatus of claim 1, wherein the alignment marks are formed along the perimeter of the surface corresponding to the intended position of the double-sided tape.

10. The plasma display apparatus of claim 9, wherein the alignment marks are formed partially along the perimeter of the surface corresponding to the intended position of the double-sided tape.

11. The plasma display apparatus of claim 10, wherein the alignment marks are formed in a pair along two lengthwise edges of the surface corresponding to the intended position of the double-sided tape.

12. The plasma display apparatus of claim 10, wherein the alignment marks are formed in a pair along two widthwise edges of the surface corresponding to the intended position of the double-sided tape.

13. The plasma display apparatus of claim 10, wherein the alignment marks are formed in a pair at diagonal positions relative to the surface corresponding to the intended position of the double-sided tape.

14. The plasma display apparatus of claim 13, wherein the alignment marks are formed in a pair at diagonal corners.

15. The plasma display apparatus of claim 14, wherein the alignment mark is formed into a partial bracket shape corresponding to a corner of the double-sided tape.

16. The plasma display apparatus of claim 14, wherein the alignment mark is formed as a hole in the chassis base.

17. The plasma display apparatus of claim 15, wherein the hole has a circular or a polygonal cross-section.

18. A plasma display apparatus comprising:
a plasma display panel;
a chassis base supporting the plasma display panel;
one or more heat spread sheets placed between the plasma display panel and the chassis base; and
alignment marks, formed on the chassis base, to indicate the attachment positions of the heat spread sheets.

19. The plasma display apparatus of claim 18, wherein the alignment marks are formed at positions corresponding to at least a portion of the heat spread sheets.

20. The plasma display apparatus of claim 18, wherein the alignment marks are formed by embossing.

21. The plasma display apparatus of claim 18, wherein the alignment marks are formed by recessing the surface of the chassis base corresponding to the intended position of the heat spread sheets.

22. The plasma display apparatus of claim 18, wherein the alignment marks are formed by printing ink or fluorescent material.

23. The plasma display apparatus of claim 18, wherein the alignment marks are formed along the perimeter of the surface corresponding to the intended position of the heat spread sheet.

24. The plasma display apparatus of claim 18, wherein the alignment marks are formed partially along the perimeter of the surface corresponding to the intended position of the heat spread sheet.

25. The plasma display apparatus of claim 18, wherein the alignment marks are formed in a pair along two lengthwise edges of the surface corresponding to the intended position of the heat spread sheet.

26. The plasma display apparatus of claim 18, wherein the alignment marks are formed in a pair along two widthwise edges of the surface corresponding to the intended position of the heat spread sheet.

27. The plasma display apparatus of claim 18, wherein the alignment marks are formed in a pair at diagonal positions relative to the surface corresponding to the intended position of the heat spread sheet.

28. The plasma display apparatus of claim 27, wherein the alignment marks are formed in a pair at diagonal corners.

29. The plasma display apparatus of claim 27, wherein the alignment mark is formed into a partial bracket shape corresponding to a corner of the heat spread sheet.

30. The plasma display apparatus of claim 27, wherein the alignment mark is formed as a hole in the chassis base.

31. The plasma display apparatus of claim 30, wherein the hole has a circular or a polygonal cross-section.
